(19) United States
(12) Patent Application Publication
(10) Pub. No.: US 2019/0229636 A1
(43) Pub. Date: Jul. 25, 2019

(54) RESONANT POWER CONVERTER AND METHOD OF RESTARTING AN OUTPUT RECTIFIER OF A RESONANT POWER CONVERTER

(71) Applicant: FRIWO Gerätebau GmbH, Ostbevern (DE)

(72) Inventor: Linzhong Xu, Greven (DE)

(21) Appl. No.: 16/256,725

(22) Filed: Jan. 24, 2019

(30) Foreign Application Priority Data
Jan. 24, 2018 (EP) 18 153 157.5

(51) Int. Cl. H02M 3/335; H02M 1/08; H02M 1/32

(52) U.S. Cl. CPC H02M 3/33592; H02M 2001/0012; H02M 1/32; H02M 1/08

(57) ABSTRACT

A resonant power converter and to a method to reduce voltage spikes across an output synchronous rectifier of a resonant converter, such as an LLC resonant converter, during restart. A resonant power converter comprises a transformer having a primary sided winding and at least one secondary sided winding, at least one primary sided switch which is controlled by a primary sided controller and is connected to said primary sided winding, a secondary sided synchronous rectifier which is controlled by a synchronous rectification controller and is connected to said at least one secondary sided winding for outputting a rectified output voltage at an output terminal, and a discharge circuit which is connected to said output terminal and is operable to lower said output voltage during startup of the resonant power converter.

### FIELD

The present invention relates to a resonant power converter and to a method to reduce voltage spikes across an output synchronous rectifier of a resonant converter, such as an LLC resonant converter, during restart.

Generally, resonant power conversion has the advantage of smooth waveforms, high efficiency, and high power density. From their physical principle, resonant converters are switching converters that include a tank circuit actively participating in determining input-to-output power flow. Resonant converters are based on a resonant inverter, i. e. a system that converts a DC voltage into a sinusoidal voltage (more generally, into a low harmonic content AC voltage), and provides AC power to a load. To do so, a switch network typically produces a square-wave voltage that is applied to a resonant tank tuned to the fundamental component of the square wave. In this way, the tank will respond primarily to this component and negligibly to the higher order harmonics, so that its voltage and/or current, as well as those of the load, will be essentially sinusoidal or piecewise sinusoidal. A resonant DC-DC converter able to provide DC power to a load can be obtained by rectifying and filtering the AC output of a resonant inverter.

Different types of DC-AC inverters can be built, depending on the type of switch network and on the characteristics of the resonant tank, i.e. the number of its reactive elements and their configuration. One advantageous type of resonant converter is the half-bridge LLC resonant converter. The LLC resonant half-bridge belongs to the family of multiresonant converters. The resonant tank includes three reactive elements, a capacitor in series with two inductors.

There are two ways to implement the magnetic components. One is to have a separate inductor plus a nearly ideal transformer which has a very small leakage inductance. The other is to use an integrated transformer which integrates the resonant inductor in the transformer. Such an integrated transformer may comprise a split bobbin, a cover, a primary winding, a secondary winding, and ferrite cores. This construction of a transformer has a large leakage inductance by separating the primary winding and the secondary winding physically by means of a split bobbin. Therefore, by using such an integrated transformer, due to the big leakage inductance, no separate resonant inductor is needed.

FIG. 1 shows a half-bridge LLC resonant converter 121 having a primary sided winding N1 and a resonant capacitor C11 connected in series with the primary sided winding N1. The primary sided winding N1 is part of an integrated transformer which integrates the resonant inductor in the transformer. However, it is apparent for a person skilled in the art that also a transformer with low leakage inductance may be used together with an additional resonant inductor.

In a resonant converter including but not limited to such a half-bridge LLC resonant converter 121, a high-side switch T11 is provided which can be a power switch including but not limited to an N-channel metal oxide semiconductor field effect transistor (MOSFET).

In order to drive the high-side switch T11, a bootstrap circuitry 122 is normally applied to obtain the supply of the floating high-side section. To ensure proper driving of the high-side switch from the first cycle, in the LLC resonant controller 123 it is customary to start the switching activity by turning on the low-side switch T12 for a preset time to pre-charge the bootstrap capacitor C12. The low-side switch T12 may comprise a power switch including but not limited to an N-channel metal oxide semiconductor field effect transistor (MOSFET). After pre-charging the bootstrap capacitor C12, the converter 121 enters a soft-start phase in order to progressively increase the converter power capability during startup to avoid excessive inrush current. The soft-start is done by sweeping the operating frequency from an initial high value until the control loop takes over because in LLC resonant converters the deliverable output power depends inversely on the operating frequency.

In applications with high output current, instead of diode rectifiers, synchronous rectification 124 is implemented to have a higher efficiency.

The synchronous rectifiers T13 and T14 that can be power switches (including but not limited to N-channel metal oxide semiconductor field effect transistors, MOSFETs) that have small on-resistance and lower forward-voltage drop than that of diode rectifiers and thus the losses caused by rectifiers can be reduced.

To drive such synchronous rectifiers, a synchronous rectification controller 125 is commonly used. On the one hand, in order to reduce the standby losses related to the synchronous rectification 124, the synchronous rectification controller 125 should be deactivated at standby or with light load. Therefore, the driver output of the synchronous rectification controller 125 is only activated when in the previous cycle, the duration that a current flows through the synchronous rectifier is longer than a minimal conduction duration ton_min. For instance, this minimal conduction duration ton_min may include but is not limited to 1 μs. FIG. 2 illustrates timing diagrams of various parameters of the converter 121 shown in FIG. 1.

As soon as the conduction duration of the synchronous rectifier is shorter than the minimal conduction duration ton_min, the driver output of the synchronous rectification controller 125 is disabled again. In this way, for the short duration pulses in burst mode at standby or with light load, the driver output of the synchronous rectification controller 125 is disabled so that the standby loss is reduced.

On the other hand, in order to eliminate false switch-off due to high frequency ringing, after switch-on of the synchronous rectifier, the switch stays in the on-state at least for a minimum duration, which is known as blanking time ton_blank, including but not limited to 0.8 μs.

As mentioned above, to pre-charge the bootstrap capacitor C12, the low-side switch T12 is switched on for a relatively long duration during which the synchronous rectifier T14 also conducts for a period of (t1-t2) as shown in FIG. 2. After this duration (t1-t2), the soft-start begins. Because the duration (t1-t2) is longer than the minimal conduction duration ton_min, next time when the synchronous rectifier T14 conducts again at instance t3, the driver output Vgs_T14 of the synchronous rectification controller 125 is enabled. Although at the instance t3, the soft-start already begins and thus the pulse duration is very short and the current flowing through the synchronous rectifier T14 is very small, the synchronous rectifier T14 is not switched off for the duration of the blanking time ton_blank. Therefore, the current flowing through T14 is not stopped although the current reaches zero.

The current flowing through T14 will flow reversely if at this moment there is still a residual voltage on the output side. The amplitude of this negative current increases linearly due to the inductance of the winding N3. The change rate of this current is proportional to the residual output voltage Vout_res. The negative current reaches its maximum amplitude until the synchronous rectification controller 125 disables its driver output after the duration of the blanking time ton_blank.

After the synchronous rectifier T14 is switched off, an oscillation occurs due to the leakage inductance of the winding N3 and the output capacitance of the synchronous rectifier Cout_T14. This oscillation causes a voltage spike across the synchronous rectifier T14 which is much higher than the voltage in normal operation and therefore can lead to a breakdown of the synchronous rectifier T14 if its voltage rating is not high enough.

In applications where the output impedance is very high, the residual voltage can remain for a very long time. In this case, when the LLC resonant converter restarts, a high voltage spike occurs across the synchronous rectifier. Even for applications where the output impedance is low, the voltage spike can also occur if the LLC resonant converter restarts shortly after switching off.

### SUMMARY OF THE INVENTION

The object underlying the present invention is to provide means for avoiding the occurrence of voltage spikes Vds_spike across the synchronous rectifier T14, at the same time allowing for an economic and simple architecture of the resonant converter.

To solve this problem, according to the present invention, a simple circuitry is used to discharge the residual voltage at the output side to a very low level or even to zero before restarting. In doing so, the above-mentioned voltage spike can be reduced to a safe level or even eliminated.

The inventor of the present invention has recognized that the residual voltage has to be discharged in order to influence the voltage spike. Because the residual output voltage Vout_res determines the change rate of the negative current, for the fixed duration of the blanking time ton_blank, it means that the residual output voltage Vout_res also determines the amplitude of the negative current Imax. The energy E stored in the leakage inductance is given by equation (1):

E=0.5*L_{leakage}*Imax² (1)

This inductive energy E is totally transferred to the capacitive energy E_{C} which can be expressed according to equation (2) when the synchronous rectifier is switched off:

E_{C}=0.5*Cₒᵤₜ_{_}_{T14}*V_{ds}_{_}ₛₚᵢₖₑ² (2)

where Cout_T14 is the output capacitance of the synchronous rectifier T14. Therefore, the residual output voltage Vout_res, which determines Imax in equation (1), determines the voltage spike Vds_spike across the synchronous rectifier T14.

In particular, a resonant power converter comprises a transformer having a primary sided winding and at least one secondary sided winding, and at least one primary sided switch which is controlled by a primary sided controller and is connected to the primary sided winding. A secondary sided synchronous rectifier is controlled by a synchronous rectification controller and is connected to the at least one secondary sided winding for outputting a rectified output voltage at an output terminal.

According to the present invention, a discharge circuit is connected to the output terminal and is operable to lower said output voltage during startup of the resonant power converter. Thereby, the following advantages are provided: No higher voltage rating synchronous rectifiers are necessary so that no additional cost increase is caused. Moreover, no additional snubbers for the synchronous rectifiers are needed so that no additional losses are generated and thus high efficiency can be reached.

According to an advantageous embodiment of the present invention, the discharge circuit is connected between said output terminal and ground, said discharge circuit comprising a discharge switch and a discharge resistor, which is connected in series between said output terminal and the discharge switch. Thus, an additional load is formed which can be connected to the output terminal in a controlled manner, thereby providing an efficient and simple means for discharging the residual output voltage.

According to a further advantageous embodiment, the resonant power converter further comprises a microcontroller for controlling the discharge circuit. This microcontroller may for instance be formed by the microcontroller that is used in a power supply unit anyway.

In case a microcontroller is used, same needs to be powered for the startup without activating the resonant power converter as such. Therefore, according to an advantageous embodiment, an auxiliary power supply is provided for powering said microcontroller at least during startup of the resonant power converter.

According to a further advantageous embodiment, the resonant power converter further comprises a voltage divider circuit which is connected in parallel to said discharge circuit and is connected to the microcontroller for measuring said output voltage. This solution has the advantage that instead of activating the discharge circuit for an estimated time span, the actual value of the residual output voltage can be used for determining when the discharging process has lowered the residual output voltage sufficiently so that dangerous voltage spikes can be avoided.

Advantageously, the resonant power converter may also comprise an enable signal input terminal for inputting a first enable signal, and a delay circuit which is connected between said enable signal input terminal and the primary sided controller for providing a second enable signal. Thereby, the enabling of the primary sided controller may be delayed until the discharge step has been performed, without the necessity of a microcontroller. Thus, a particularly simple and economic power supply can be realized.

In order to ensure that the discharging is performed, a pullup circuit may be connected to said enable signal input terminal for activating said discharge circuit before the second enable signal is provided to the primary sided controller. Furthermore, a feedback switch may be provided, which is controlled by the second enable signal for de-activating said discharge circuit and said pullup circuit.

The advantages of the solution according to the present invention may best be used in connection when the resonant power converter is formed as a half-bridge LLC resonant converter. However, it is clear for a person skilled in the art that any other type of resonant converter may also be adapted to comprise discharge circuitry according to the present invention.

According to an advantageous embodiment of the present invention, the discharge switch comprises an N-channel metal oxide semiconductor field effect transistor (MOSFET). This is a particularly economic choice. However, it is clear for a person skilled in the art that all other suitable switches, e.g. insulated gate bipolar transistors (IGBTs), may also be used.

The present invention further relates to a method of restarting an output rectifier of a resonant power converter. The method comprises the following steps:

activating said resonant power converter for exiting a standby mode of said resonant power converter by inputting a first enable signal,

activating a discharge circuit, wherein the discharge circuit is connected to an output terminal of the resonant power converter, so that a residual output voltage at the output terminal is reduced,

after the discharge step has been performed, providing a second enable signal for enabling the operation of the resonant power converter.

According to an advantageous embodiment, a minimum delay time between activating the discharge circuit and outputting the second enable signal is determined. This time may either be derived from measurements or may be calculated. For instance, the minimum delay time may be calculated as the time a maximum possible residual output voltage needs to be discharged to zero.

In order to yield more accurate information as to when the second enable signal may be activated safely, the method may further comprise the step of measuring a residual output voltage at the output terminal, wherein the second enable signal is output after the measured residual output voltage has fallen below a predetermined threshold.

According to one possible embodiment of the present invention, the first enable signal is received by a microcontroller, wherein the second enable signal is generated by the microcontroller. For instance when using the present invention with a battery charger, such a charger usually has a microcontroller that controls and monitors the operation of the charger. This microcontroller can be adapted to support the method according to the present invention.

However, the method according to the present invention can also be performed using an analog circuitry. Advantageously, the first enable signal is received by a delay circuit which generates the second enable signal as the delayed first enable signal. In this case, the discharge circuit may be activated by the first enable signal in order to ensure that the discharging has been performed before the second enable signal is generated.

### BRIEF DESCRIPTION OF THE DRAWINGS

The accompanying drawings are incorporated into the specification and form a part of the specification to illustrate several embodiments of the present invention. These drawings, together with the description serve to explain the principles of the invention. The drawings are merely for the purpose of illustrating the preferred and alternative examples of how the invention can be made and used, and are not to be construed as limiting the invention to only the illustrated and described embodiments. Furthermore, several aspects of the embodiments may form-individually or in different combinations-solutions according to the present invention. The following described embodiments thus can be considered either alone or in an arbitrary combination thereof. Further features and advantages will become apparent from the following more particular description of the various embodiments of the invention, as illustrated in the accompanying drawings, in which like references refer to like elements, and wherein:

FIG. 1 is a schematic circuit diagram of a half-bridge LLC resonant converter;

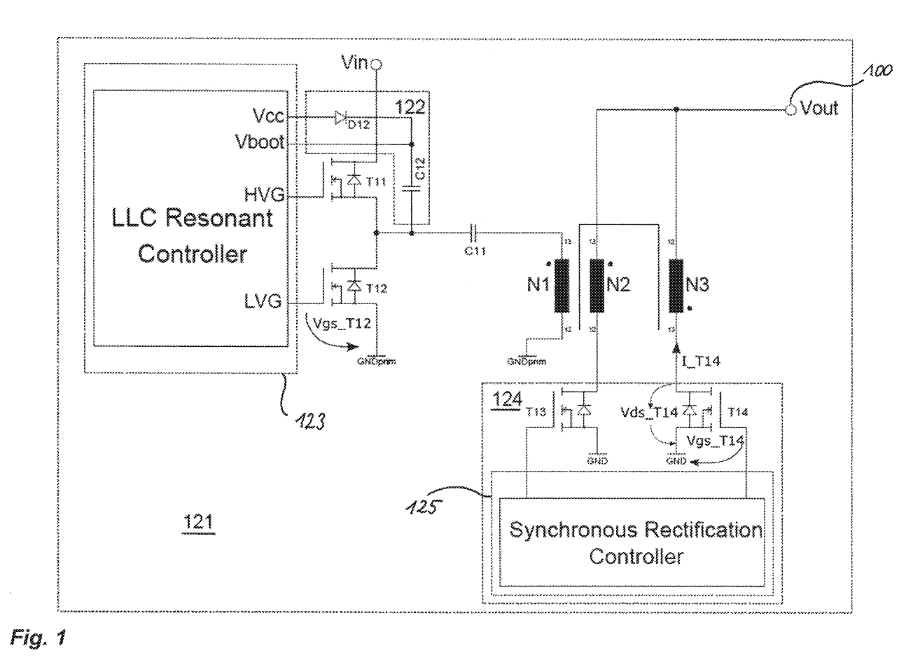

FIG. 2 is a schematic timing diagram illustrating the operation of the circuit shown in FIG. 1;

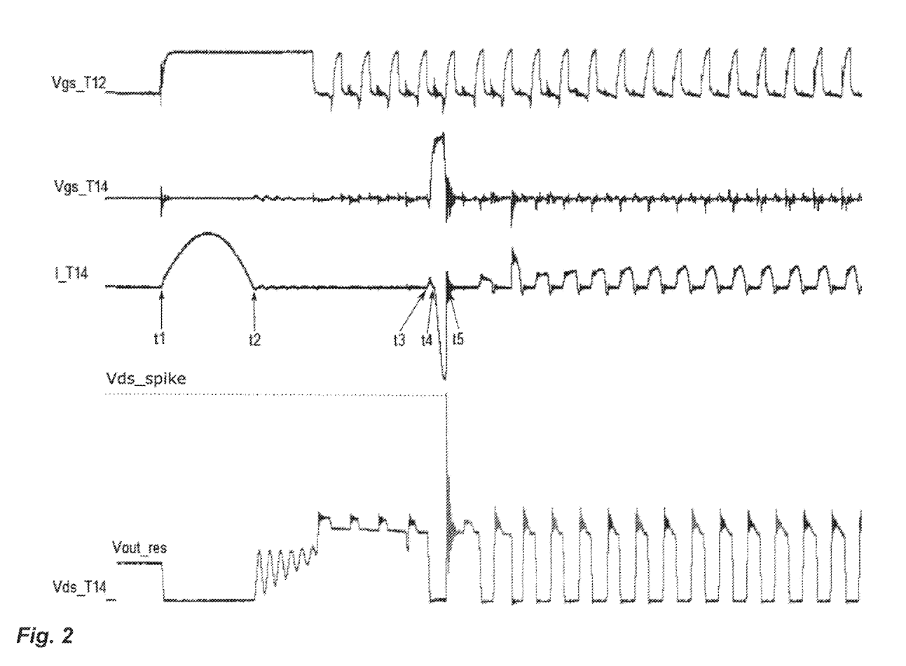

FIG. 3 is a schematic circuit diagram of a first protective circuit for an LLC resonant converter according to the present invention;

FIG. 4 is a schematic circuit diagram of a second protective circuit for an LLC resonant converter according to the present invention.

### DETAILED DESCRIPTION

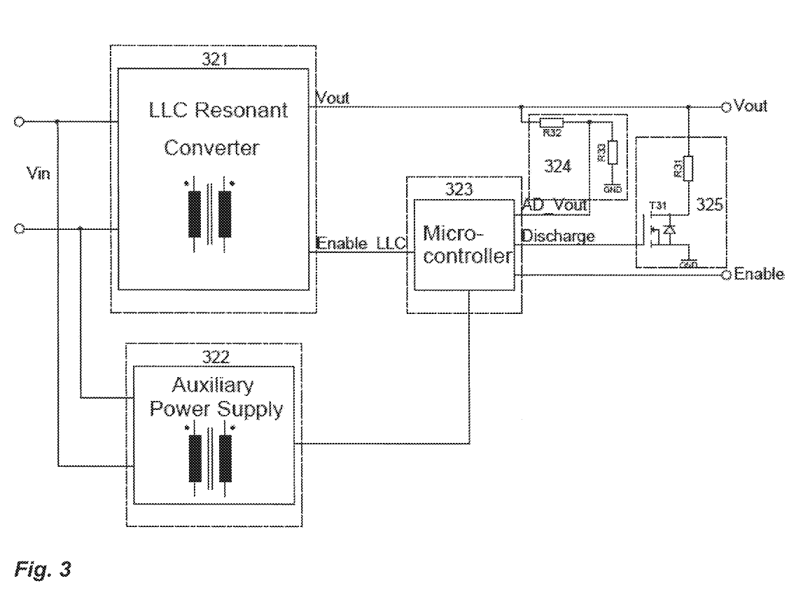

The present invention will now be explained in more detail with reference to the Figures and firstly referring to FIG. 3.

FIG. 3 shows an exemplary embodiment of protective circuitry according to the present invention that can be employed with a microcontroller being already used. For instance when using the present invention with a battery charger, such a charger usually has a microcontroller that controls and monitors the operation of the charger. This microcontroller can be adapted to support the method according to the present invention.

In such applications including but not limited to battery chargers, a microcontroller 323 is already used for other purposes. To reduce the standby losses, the main converter, in this case, the LLC resonant converter 321 is disabled in standby mode and the microcontroller 323 is supplied by an auxiliary power supply 322.

Upon an event, the power converter needs to exit the standby mode. But due to the high output impedance, the residual voltage at Vout is still rather high. In this case, if the LLC resonant converter is directly switched on without discharging the Vout, a high voltage spike occurs across the synchronous rectifier T14 which can lead to a breakdown of the synchronous rectifier T14 as described above.

Since the microcontroller 323 is already available, the output voltage is easily to be discharged by adding a discharge circuitry 325. After the microcontroller 323 received the command “exiting the standby mode” through the enable signal, the microcontroller 323 does not directly enable the LLC resonant converter 321 but activates the discharge circuitry 325 by the I/O pin “Discharge”. After a minimum delay which can be determined by calculation or measurement, the output voltage Vout is discharged low enough, the LLC resonant converter 321 is enabled by the microcontroller 323 through the I/O pin “Enable_LLC”. The minimum delay should be determined in worst case with maximum residual output voltage on Vout.

Even better, if an ADC channel of the microcontroller 323 is still available, by adding a voltage divider circuitry 324, the residual voltage on Vout can be monitored by the microcontroller 323. After a low enough voltage at Vout is detected, the microcontroller 323 enables the LLC resonant converter 321.

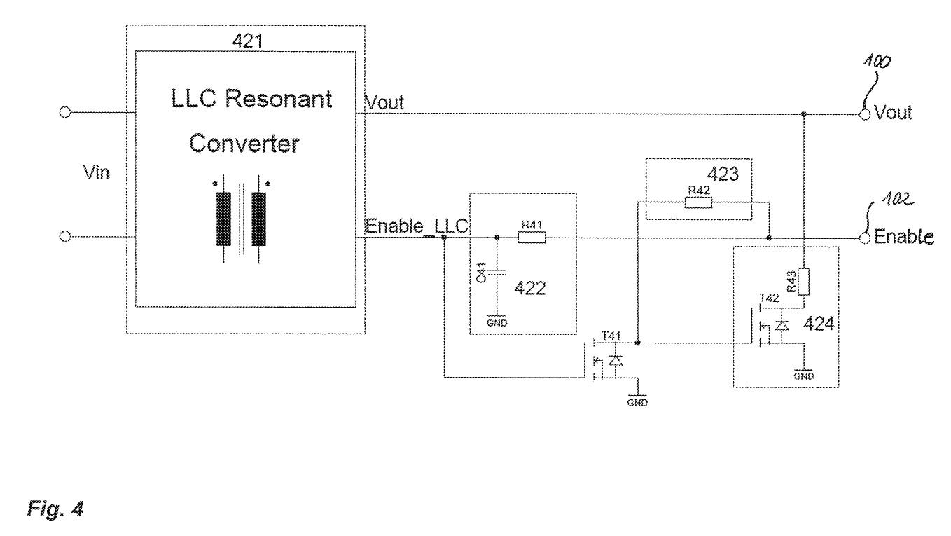

For applications without a microcontroller being used, the solution as shown in FIG. 4 is an example. The first enable signal Enable and the second enable signal Enable_LLC are decoupled through the delay circuitry 422. When the first enable signal Enable is received, due to the pullup circuitry 423, the discharge circuitry 424 is first enabled.

After the certain delay time caused by the delay circuitry 422, the Enable_LLC is high enough to turn on the switching element T41 which pulls down the voltage on the gate of the switching element T42 leading to disable the discharge circuitry 424. At this moment, the residual voltage on Vout is already low enough so that the restart of the LLC resonant converter 421 does not cause any voltage spikes across the synchronous rectifier T14.

### REFERENCE NUMERALS

| Reference Numeral | Description |
|---|---|
| 100 | Output terminal |
| 102 | Enable signal input terminal |
| 121, 321, 421 | Half-bridge LLC resonant converter |
| 122 | Bootstrap circuit |
| 123 | LLC resonant controller |
| 124 | Synchronous rectifier |
| 125 | Synchronous rectification controller |
| 322 | Auxiliary power supply |
| 323 | Microcontroller |
| 324 | Voltage divider circuit |
| 325 | Discharge circuit |
| 422 | Delay circuit |
| 423 | Pullup circuit |
| 424 | Discharge circuit |
| First enable signal | Enable |
| Second enable signal | Enable_LLC |
| Vout | Output voltage |

1. A resonant power converter comprising:
a transformer having a primary sided winding and at least one secondary sided winding,
at least one primary sided switch which is controlled by a primary sided controller and is connected to said primary sided winding,
a secondary sided synchronous rectifier which is controlled by a synchronous rectification controller and is connected to said at least one secondary sided winding for outputting a rectified output voltage at an output terminal, and
a discharge circuit which is connected to said output terminal and is operable to lower said output voltage during startup of the resonant power converter.

2. The resonant power converter of claim 1, wherein the discharge circuit is connected between said output terminal and ground, said discharge circuit comprising a discharge switch and a discharge resistor, which is connected in series between said output terminal and the discharge switch.

3. The resonant power converter of claim 1, wherein the resonant power converter further comprises a microcontroller for controlling the discharge circuit.

4. The resonant power converter of claim 3, further comprising an auxiliary power supply for powering said microcontroller.

5. The resonant power converter of claim 3, further comprising a voltage divider circuit which is connected in parallel to said discharge circuit and is connected to the microcontroller for measuring said output voltage.

6. The resonant power converter of claim 1, further comprising an enable signal input terminal for inputting a first enable signal, and a delay circuit which is connected between said enable signal input terminal and the primary sided controller for providing a second enable signal.

7. The resonant power converter of claim 6, further comprising a pullup circuit which is connected to said enable signal input terminal for activating said discharge circuit before the second enable signal is provided to the primary sided controller.

8. The resonant power converter of claim 7, further comprising a feedback switch which is controlled by the second enable signal for de-activating said discharge circuit and said pullup circuit.

9. The resonant power converter of claim 1, wherein said resonant power converter is formed as a half-bridge LLC resonant converter.

10. The resonant power converter of claim 1, wherein the discharge switch comprises an N-channel metal oxide semiconductor field effect transistor, MOSFET.

11. A method of restarting an output rectifier of a resonant power converter, said method comprising:
activating said resonant power converter for exiting a standby mode of said resonant power converter by inputting a first enable signal,
activating a discharge circuit, wherein the discharge circuit is connected to an output terminal of the resonant power converter, so that a residual output voltage at the output terminal is reduced,
after the discharge step has been performed, providing a second enable signal for enabling the operation of the resonant power converter.

12. The method of claim 11, wherein a minimum delay time between activating the discharge circuit and outputting the second enable signal is determined.

13. The method of claim 12, wherein the minimum delay time is calculated as the time a maximum possible residual output voltage needs to be discharged to zero.

14. The method of claim 11, further comprising the step of measuring a residual output voltage at the output terminal, wherein the second enable signal is output after the measured residual output voltage has fallen below a predetermined threshold.

15. The method of claim 11, wherein the first enable signal is received by a microcontroller, and wherein the second enable signal is generated by the microcontroller.

16. The method of claim 11, wherein the first enable signal is received by a delay circuit which generates the second enable signal as the delayed first enable signal.

17. The method of claim 16, wherein the discharge circuit is activated by the first enable signal.
